(19) United States
(12) Patent Application Publication
(10) Pub. No.: US 2020/0240208 A1
(43) Pub. Date: Jul. 30, 2020

(54) RUNG MOUNTING STRUCTURE USED FOR LADDER

(71) Applicant: Jiangsu Zhou Jijie Intelligent Technology Co.,Ltd, Suqian (CN)

(72) Inventors: CHEN HUI ZHU, Suqian (CN); BAISONG YAO, Suqian (CN)

(73) Assignee: Jiangsu Zhou Jijie Intelligent Technology Co.,Ltd, Suqian (CN)

(21) Appl. No.: 16/296,226

(22) Filed: Mar. 8, 2019

(30) Foreign Application Priority Data
Jan. 25, 2019 (CN) 201920131324.7

(51) Int. Cl. E06C 7/08

(52) U.S. Cl. CPC E06C 7/087; E06C 7/084

(57) ABSTRACT

A rung mounting structure used for a ladder includes supporting legs, a rung and a connecting plate, wherein upper ends of the two supporting legs are connected through the connecting plate, the rung is arranged between the supporting legs, the supporting legs are made of metal sections, concave parts are arranged on inner sides of the supporting legs and each are provided with an opening allowing the rung to be inserted therein, and the sides, opposite to the openings, of the concave parts are sealed; and after the rung is inserted into the concave parts, the rung and the supporting legs are circumferentially limited and are fixedly connected.

### CROSS REFERENCE TO RELATED APPLICATIONS

This application is based upon and claims priority to Chinese Patent Application No. 201920131324.7, filed on Jan. 25, 2019, the entire contents of which are incorporated herein by reference.

### TECHNICAL FIELD

The invention relates to a rung mounting structure used for a ladder, and belongs to the technical field of household articles.

### BACKGROUND

Ladders are common tools used in daily work. Existing ladders usually include a pair of ladder legs and rungs, wherein the rungs are disposed between the two ladder legs, are used for connecting the ladder legs on two sides and sometimes are used as load bearing components, and thus, the connecting structures between the rungs and the ladder legs are of particular importance. Existing connecting structures between the rungs and the ladder legs are designed in such a manner that through holes allowing the rungs to stretch therein are formed in the ladder legs and the rungs stretch into the through holes to be fixedly riveted on the ladder legs. Although such structures are convenient to assemble, the through holes reduce the bending resistance of the ladder legs, and consequentially, the overall load bearing performance of ladders is reduced.

### SUMMARY

The objective of the invention is to overcome the above defects of the prior art by providing a rung mounting structure which is used for a ladder and is reasonable in structural design, convenient and fast to mount and good in load bearing performance.

According to the technical solution adopted by the invention to fulfill the above objective, a rung mounting structure used for a ladder includes supporting legs and a rung, wherein the rung is arranged between the supporting legs, the supporting legs are made of metal sections, concave parts are arranged on inner sides of the supporting legs and each is provided with an opening allowing the rung to be inserted therein, and the sides, opposite to the openings, the concave parts are sealed; and after the rung is inserted into the concave parts, the rung and the supporting legs are circumferentially limited and are fixedly connected.

Further, the rung mounting structure further includes a connecting piece; the connecting piece includes a bottom face, two sides of the bottom face are bent to form two opposite first side faces, a gap allowing the rung to be inserted therein is reserved between the two first side faces, and the ends, away from the bottom face, of the two first side faces are bent outwards to form flanges; and after the connecting piece is assembled with the supporting legs, the bottom face and the first side faces of the connecting piece fall into the concave parts, the rung is arranged between the two first side faces, and the flanges are fixedly connected to the supporting legs through fasteners.

Further, second side faces are arranged between the two first side faces and are formed by bending extension sections of the bottom face or the first side faces.

Further, the first side faces of the connecting piece abut against the concave parts, and the connecting piece is supported by the concave parts.

Further, the first side faces or the second side faces of the connecting piece abut against the concave parts, and the connecting piece is supported by the concave parts.

Further, the supporting legs and the rung are made of aluminum alloy sections, and the connecting piece is air iron piece.

Further, the rung mounting structure further includes a mounting piece; the mounting piece includes a sleeve body having two open ends, and a mounting plate is fixedly arranged on the sleeve body; and after the mounting piece is assembled with the supporting legs, the sleeve body completely or partially falls into the concave parts and is arranged around the rung, and the mounting plate is fixedly connected to the supporting legs through fasteners.

Further, an outer wall of the sleeve body abuts against the concave parts, and the mounting piece is supported by the concave parts.

Further, the supporting legs and the rung are made of aluminum alloy sections, and the mounting piece is an iron piece.

Further, the rung extends in the width direction to form a pedal part, and two ends of the pedal part are concaved inwards relative to the ends of the rung; and after the rung is assembled with the supporting legs, the two ends of the pedal part are closely attached to inner sides of the supporting legs.

Further, the cross section of the rung is noncircular.

Compared with the prior art, the invention has the following advantages and effects: the concave parts are arranged only on the inner sides of the supporting legs and are of a non-through structure, so that the bending resistance of the supporting legs provided with the concave parts is better and more reliable than that of existing through-type mounting methods.

### BRIEF DESCRIPTION OF THE DRAWINGS

FIG. 1 is a structural view of the invention.

FIG. 2 is a structural view of a connecting piece of the invention.

FIG. 3 is a structural view of another implementation of the connecting piece of the invention.

FIG. 4 is a structural view of a mounting piece of the invention.

FIG. 5 is a structural view of the mounting structure after rungs extend in a width direction to form pedal parts of the invention.

### DETAILED DESCRIPTION OF THE EMBODIMENTS

The invention is further expounded below with reference to the accompanying drawings and embodiments. The following embodiments are used to explain the invention, but are not intended to limit the invention.

### Embodiment 1

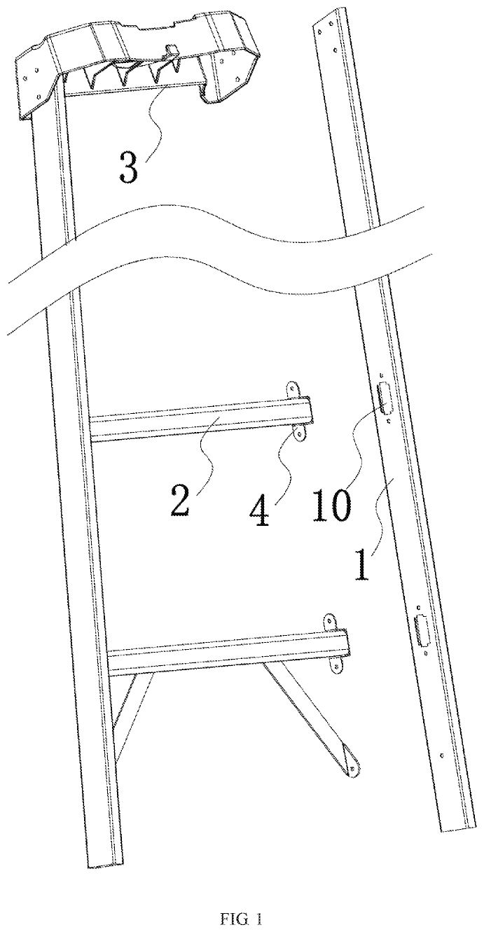

Referring to FIGS. 1-5, in this embodiment, a rung 2 mounting structure used for a ladder includes, as shown in FIG. 1, two supporting legs 1 and a rung 2, wherein upper ends of the two supporting legs 1 are connected through a connecting plate 3, and the rung 2 is arranged between the supporting legs 1; the supporting legs 1 are made of metal sections, and preferably, the supporting legs 1 and the rung 2 are made of aluminum alloy sections; concave parts 10 are arranged on inner sides of the supporting legs 1 and are provided with openings allowing the rung 2 to be inserted therein, and the sides, opposite to the openings, of the concave parts 10 are sealed. In this embodiment, the concave parts 10 are preferably holes formed only in the inner sides of the supporting legs 1 and having one ends sealed, so that compared with existing connecting structures provided with through holes, the bending resistance of the supporting legs 1 is greatly enhanced, and the load-bearing capacity of the supporting legs 1 is improved. Preferably, the contour of the concave parts 10 is noncircular and particularly can be rectangular, elliptical, pentagonal or hexagonal. Preferably, the cross section of the rung 2 is rectangular, elliptical, pentagonal or hexagonal correspondingly. After the rung 2 is inserted into the concave parts 10, the rung 2 and the supporting legs 1 are circumferentially limited and cannot rotate. After the rung 2 is inserted into the concave parts 10, the rung 2 is fixedly connected to the supporting legs 1 through fasteners or other existing techniques.

Preferably, the cross section of the rung 2 in this embodiment is noncircular and particularly can be rectangular, elliptical, pentagonal, hexagonal or the like. The rung 2 of this structure can be conveniently and rapidly manufactured through cold drawing and can be circumferentially limited together with the supporting legs 1.

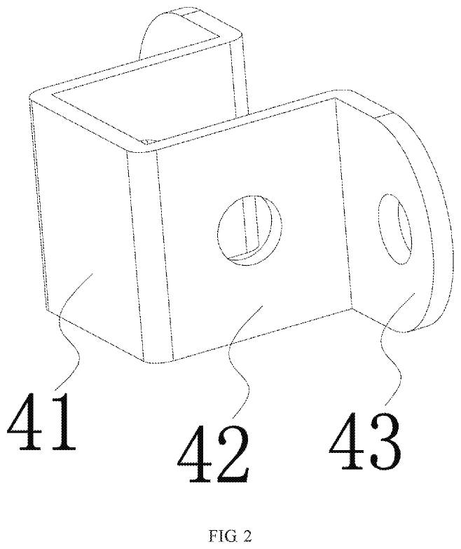

As shown in FIG. 2, the rung mounting structure in this embodiment further includes a connecting piece 4, wherein the connecting piece 4 includes a bottom face 41, two sides of the bottom face 41 are bent to form two opposite first side faces 42, a gap allowing the rung 2 to be inserted therein is reserved between the two first side faces 42, and the ends, away from the bottom face 41, of the two first side faces 42 are bent outwards to form flanges 43. After being assembled, the bottom face 41 and the first side faces 42 of the connecting piece 4 fall into the concave parts 10, the rung 2 having the rectangular or elliptical cross section is arranged between the two first side faces 42 and is clamped by the two first side faces 42, and thus, the connecting piece 4 and the rung 2 are stably and reliably connected. The flanges 43 are connected to the supporting legs 1 on the periphery of the concave parts 10 through fasteners. Preferably, the connecting piece 4 is an iron piece, the first side faces 42 and the flanges 43 are formed by punching the same iron plate, the connecting piece 4 is arranged between the rung 2 and each supporting leg 1, and the strength of the iron connecting piece 4 is better than that of the aluminum alloy rung 2, so that after being assembled, the rung 2 and the supporting leg 1 can be more stably connected through the connecting piece 4 to the excellent stress performance.

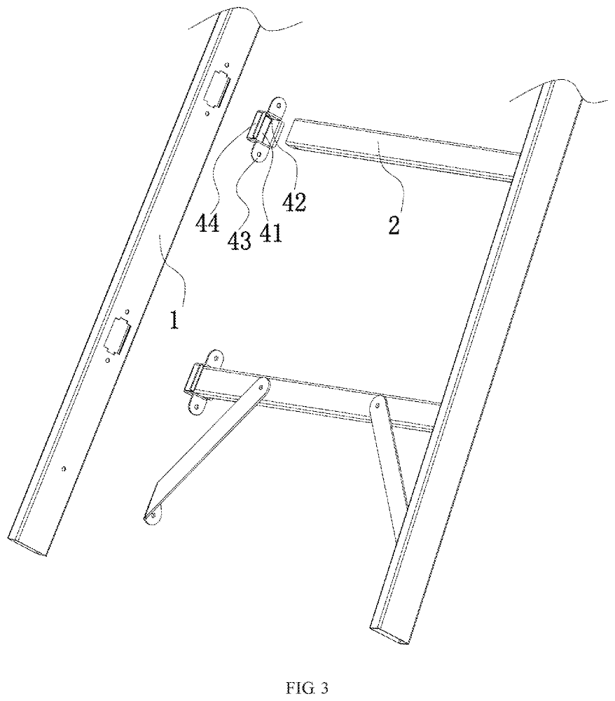

FIG. 3 shows another implementation of the connecting piece 4 in this embodiment. According to this implementation, second side faces 44 are arranged between the two first side faces 42 of the connecting piece 4, and the second side faces 44 are fixedly connected to the bottom face 41 or the first side faces 42. Extension sections of the bottom face 41 or the first side faces 42 are bent to form the second side faces 44. The rung 2 is surrounded all around by the two first side faces 42 and the two second side faces 44, so that the rung 2 is more comprehensively limited by the connecting piece 4. In this embodiment, all-around surrounding is not limited to seamless surrounding and also includes surrounding with gaps formed at junctions between the first side faces 42 and the second side faces 44.

In this embodiment, the first side faces 42 of the connecting piece 4 abuts against the concave parts 10, and the connecting piece 4 is supported by the concave parts 10. The connecting piece 4 enlarges the supporting area, so that deformation caused by local stress or non-uniform stress of the concave parts 10 is avoided.

In this embodiment, the first side faces 42 or the second side faces 44 of the connecting piece 4 abut against the concave parts 10, and the connecting piece 4 is supported by the concave parts 10. The connecting piece 4 enlarges the supporting area, so that deformation caused by local stress or non-uniform stress of the concave parts 10 is avoided.

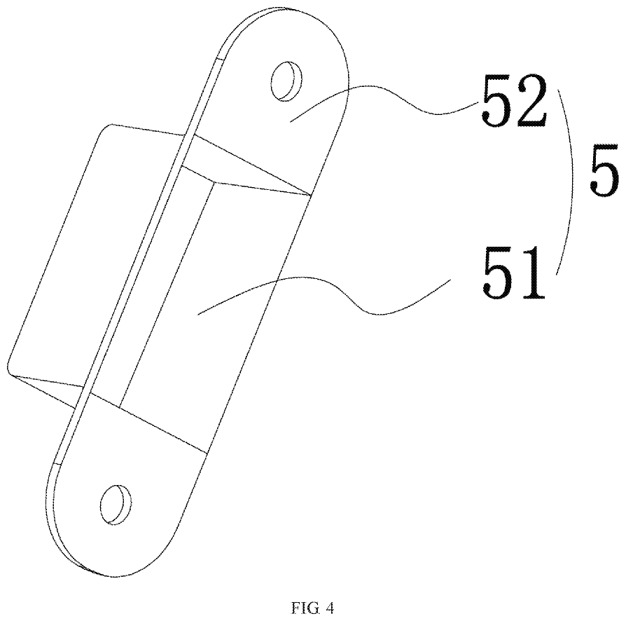

As shown in FIG. 4, the rung mounting structure in this embodiment further includes a mounting piece 5, wherein the mounting piece 5 includes a sleeve body 51 having two open ends, so that mounting and positioning are facilitated. A mounting plate 52 is fixedly arranged on the sleeve body 51. After being assembled, the sleeve body 51 completely or partially falls into the concave parts 10 and is arranged around the rung 2, the mounting plate 52 is fixed to the supporting legs 1 through fasteners, and the fasteners are preferably rivets. Preferably, the mounting piece 5 is an iron piece, the sleeve body 51 is rectangular, elliptical or pentagonal, the rung 2 is surrounded all around by the sleeve body 51, and the sleeve body 51 having the two open ends is low in weight and can still fulfill a good load-bearing effect. In this embodiment, all-around surrounding of the rung 2 by the sleeve body 51 does not limit seamless surrounding and also includes the condition that the sleeve body 51 has joint seams.

In this embodiment, an outer wall of the sleeve body 51 abuts against the concave parts 10, and the mounting piece 5 is supported by the concave parts 10, so that deformation caused by local stress or non-uniform stress of the concave parts 10 is avoided.

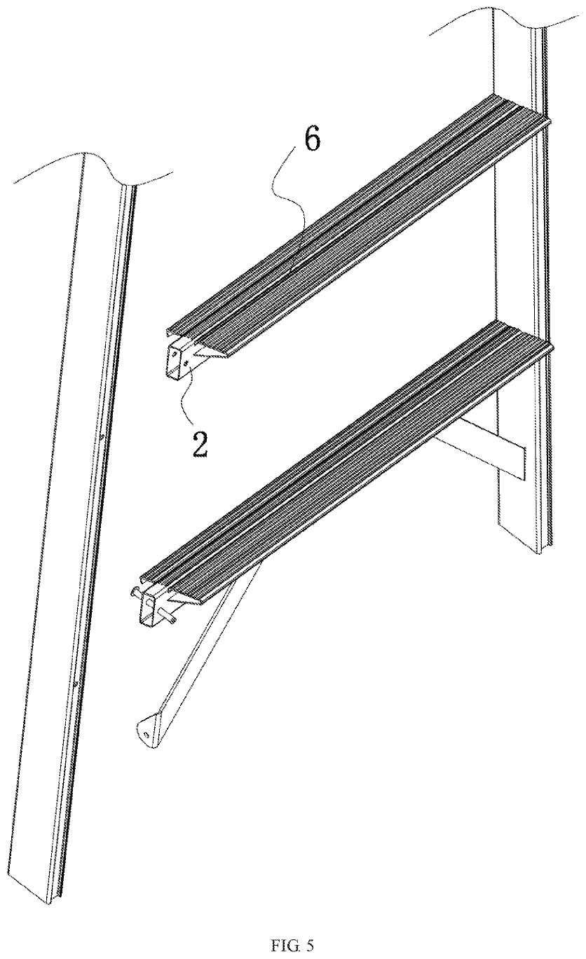

As shown in FIG. 5, the rung 2 in this embodiment extends in the width direction to form a pedal part 6, two ends of the pedal part 6 are concaved inwards relative to the ends of the rung 2, and after being assembled, the two ends of the pedal part 6 are closely attached to the inner sides of the supporting legs 1. After being assembled, the supporting legs 1 are supported by the pedal part 6 to inwards draw close to each other. After the rung 2 is fixedly connected to the two supporting legs 1, the two supporting legs 1 are pulled by the rung 2 to be prevented from being outwards separated from each other. After being assembled, the rung mounting structure is stressed in two directions, thereby being stable and reliable. Preferably, the pedal part 6 and the rung 2 are integrally formed. The rung 2 formed with the pedal part 6 is directly connected to the supporting legs 1 through fasteners or is fixedly connected to the supporting legs 1 through the connecting piece 4 or the mounting piece 5.

The above embodiments in the specification are only illustrative ones of the invention. Various modifications, supplements or similar substitutes of these specific embodiments made by those skilled in this field without deviating from the contents in the specification or going beyond the scope defined by the claims should also fall within the protection scope of the invention.

What is claimed is:

1. A rung mounting structure used for a ladder, comprising supporting legs and a rung arranged between the supporting legs, wherein the supporting legs are made of metal sections; concave parts are arranged on inner sides of the supporting legs, and each of the concave parts is provided with an opening; the rung is allowed to be inserted in the opening; sides, opposite to the openings, of the concave parts are sealed; and after the rung is inserted into the concave parts, the rung and the supporting legs are circumferentially limited and are fixedly connected.

2. The rung mounting structure used for the ladder according to claim 1, wherein the rung mounting structure further comprises a connecting piece; the connecting piece comprises a bottom face; two sides of the bottom face are bent to form two first side faces opposite to each other; the rung is allowed to be inserted in the a gap; the gap is reserved between the two first side faces; ends, away from the bottom face, of the two first side faces are bent outwards to form flanges; after the connecting piece is assembled with the supporting legs, the bottom face and the two first side faces of the connecting piece fall into the concave parts; the rung is arranged between the two first side faces; and the flanges are fixedly connected to the supporting legs through fasteners.

3. The rung mounting structure used for the ladder according to claim 2, wherein second side faces are arranged between the two first side faces and are formed by bending extension sections of the bottom face or the two first side faces.

4. The rung mounting structure used for the ladder according to claim 3, wherein the two first side faces of the connecting piece abut against the concave parts, and the supporting piece is supported by the concave parts.

5. The rung mounting structure used for the ladder according to claim 4, wherein the two first side faces or the second side faces of the connecting piece abut against the concave parts, and the connecting piece are supported by the concave parts.

6. The rung mounting structure used for the ladder according to claim 2, wherein the supporting legs and the rung are made of aluminum alloy sections, and the connecting piece is an iron piece.

7. The rung mounting structure used for the ladder according to claim 1, wherein the rung mounting structure further comprises a mounting piece; the mounting piece comprises a sleeve body having two open ends; a mounting plate is fixedly arranged on the sleeve body; after the mounting piece is assembled with the supporting legs, the sleeve body completely or partially falls into the concave parts and is arranged around the rung; and the mounting plate is fixedly connected to the supporting legs through fasteners.

8. The rung mounting structure used for the ladder according to claim 7, wherein an outer wall of the sleeve body abuts against the concave parts, and the mounting piece is supported by the concave parts.

9. The rung mounting structure used for the ladder according to claim 7, wherein the supporting legs and the rung are made of aluminum alloy sections, and the mounting piece is an iron piece.

10. The rung mounting structure used for the ladder according to claim 1, wherein the rung extends in a width direction to form a pedal part; two ends of the pedal part are concaved inwards relative to ends of the rung; and after the rung is assembled with the supporting legs, the two ends of the pedal part are closely attached to the inner sides of the supporting legs.

11. The rung mounting structure used for the ladder according to claim 1, wherein a cross section of the rung is noncircular.

12. The rung mounting structure used for the ladder according to claim 3, wherein the supporting legs and the rung are made of aluminum alloy sections, and the connecting piece is an iron piece.

13. The rung mounting structure used for the ladder according to claim 4, wherein the supporting legs and the rung are made of aluminum alloy sections, and the connecting piece is an iron piece.

14. The rung mounting structure used for the ladder according to claim 5, wherein the supporting legs and the rung are made of aluminum alloy sections, and the connecting piece is an iron piece.

15. The rung mounting structure used for the ladder according to claim 8, wherein the supporting legs and the rung are made of aluminum alloy sections, and the mounting piece is an iron piece.
